(19) United States
(12) Patent Application Publication
(10) Pub. No.: US 2015/0006487 A1
(43) Pub. Date: Jan. 1, 2015

(54) METHOD AND APPARATUS FOR CHECKPOINTING AND RESTARTING CONTAINER STATUS

(71) Applicant: Huawei Technologies Co., Ltd., Shenzhen (CN)

(72) Inventors: Zhenzhang Yang, Hangzhou (CN); Qi Zhao, Hangzhou (CN)

(21) Appl. No.: 14/486,099

(22) Filed: Sep. 15, 2014

Related U.S. Application Data
(63) Continuation of application No. PCT/CN2012/072358, filed on Mar. 15, 2012.

(51) Int. Cl. G06F 11/14

(52) U.S. Cl. CPC G06F 11/1458
USPC 707/649

(57) ABSTRACT

Embodiments of the present invention disclose a method for checkpointing and restarting a container status, including: at a checkpoint stage, acquiring and checkpointing configuration information of a first container, a control group status parameter of the first container, and an application program status parameter of the first container; and at a restart stage, reading the configuration information, the control group status parameter, and the application program status parameter, and configure a second container according to the read configuration information, the read control group status parameter, and the read application program status parameter. The embodiments of the present invention further disclose an apparatus for checkpointing and restarting a container status, so that an execution environment of a process in the container can be kept consistent before and after a checkpoint/restart operation.

### CROSS-REFERENCE TO RELATED APPLICATION

This application is a continuation of International Application No. PCT/CN2012/072358, filed on May 15, 2012, which is hereby incorporated by reference in its entirety.

### TECHNICAL FIELD

Embodiments of the present invention relate to the field of computer technologies, and in particular, to a method and an apparatus for checkpointing and restarting a container status.

### BACKGROUND

A Linux container can provide lightweight virtualization, so as to isolate a group of processes and control resource utilization of the group of processes. A principle of the Linux container is that different system views are provided for different processes, inter-process isolation is implemented by using a Linux namespace mechanism, and processes in a same namespace can be mutually seen, mutually accessed and mutually communicated, where a namespace is a collection of resource localization and is formed by combining namespaces of a plurality of subsystems. For an object of each subsystem, an original and globally unique instance is localized into a plurality of instances, the plurality of instances does not interfere with each other, and one instance cannot access an element inside another instance.

In the prior art, a Linux container controls processes in the container to access hardware resources by using a control group (cgroup, control group) mechanism of a kernel in a Linux system. For example, if a central processing unit (CPU, Central Processing Unit) usage of a process A is limited to 20%, a cgroup with a CPU usage of 20% can be established, and then, when the process A is added to the established cgroup, the CPU usage of the process A can be controlled within 20%. Certainly, one cgroup may include a plurality of processes, and functions of the cgroup are mainly implemented by a subsystem of the cgroup. For example, the foregoing example is a subsystem that implements CPU usage control. Currently, functions that can be implemented by all subsystems of a cgroup include: limiting an input/output (I/O Input/Output) port of a block device, limiting a CPU usage, limiting an access right of a device, freezing or defreezing a container, limiting a memory size, limiting a memory node, and the like.

With the development of checkpoint/restart (checkpoint and restart) technologies, when a user maintains a system, a container usually needs to be checkpointed and restarted, including checkpointing and restarting a container status and an application program status in the container. Specifically, when a checkpoint/restart operation needs to be performed, a freezing subsystem in a Linux cgroup is used to perform a freezing operation on the container, so as to suspend execution of an application program in the container.

After the freezing is complete, at a checkpoint stage, a controller checkpoints a status parameter of the application program that runs in a first container to an image file of a shared memory, where the status parameter of the application program includes an application program accessible resource status and a kernel data status for controlling an application program behavior; and then at a restart stage, the controller reads the status parameter of the application program in the image file stored on the shared memory, and restarts the application program in a second container.

However, a checkpoint/restart operation in the prior art has a problem: at a restart stage, a resource limit of a process in a restarted container is lost, and an execution environment of the process in the container is inconsistent before and after the checkpoint/restart operation.

### SUMMARY

Embodiments of the present invention provide a method and an apparatus for checkpointing and restarting a container status, which are used for performing a checkpoint/restart operation on a container status in a Linux system, so that an execution environment of a process in the container can be kept consistent before and after the checkpoint/restart operation.

A method for checkpointing and restarting a container status according to an embodiment of the present invention includes:

at a checkpoint stage, acquiring and checkpointing configuration information of a first container, a control group status parameter of the first container, and an application program status parameter of the first container; and

at a restart stage, reading the configuration information of the first container, the control group status parameter of the first container, and the application program status parameter of the first container, and configuring a second container according to the read configuration information of the first container, the read control group status parameter of the first container, and the read application program status parameter of the first container.

An apparatus for checkpointing and restarting a container status according to an embodiment of the present invention includes:

a checkpoint module, configured to, at a checkpoint stage, acquire and checkpoint configuration information of a first container, a control group status parameter of the first container, and an application program status parameter of the first container; and

a restart module, configured to, at a restart stage, read the configuration information of the first container, the control group status parameter of the first container, and the application program status parameter of the first container, and configure a second container according to the read configuration information of the first container, the read control group status parameter of the first container, and the read application program status parameter of the first container.

It can be learned from the foregoing technical solutions that the embodiments of the present invention have the following advantages:

At a checkpoint stage, configuration information of a first container, a control group status parameter of the first container, and an application program status parameter of the first container are acquired and checkpointed, so that a second container can be configured at a restart stage according to the checkpointed configuration information of the first container, the checkpointed control group status parameter of the first container, and the checkpointed application program status parameter of the first container. In this case, the second container can have the same configuration information as the configuration information of the first container, and a resource limit condition of a process in the second container is kept consistent before and after a checkpoint/restart operation, and an execution environment is kept unchanged.

### BRIEF DESCRIPTION OF THE DRAWINGS

FIG. 1 is a schematic diagram of a method for checkpointing and restarting a container status according to an embodiment of the present invention;

FIG. 2 is another schematic diagram of a method for checkpointing and restarting a container status according to an embodiment of the present invention;

FIG. 3 is a schematic diagram of an apparatus for checkpointing and restarting a container status according to an embodiment of the present invention; and

FIG. 4 is another schematic diagram of an apparatus for checkpointing and restarting a container status according to an embodiment of the present invention.

### DETAILED DESCRIPTION

Embodiments of the present invention provide a method and an apparatus for checkpointing and restarting a container status, which are used for performing a checkpoint/restart operation on a container status in a Linux system, so that an execution environment of a process in the container can be kept consistent before and after the checkpoint/restart operation.

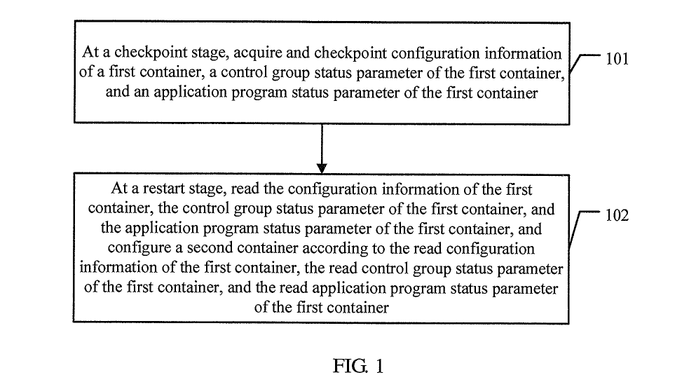

To better understand the technical solutions of the present invention, refer to FIG. 1. which shows an embodiment of a method for checkpointing and restarting a container status according to an embodiment of the present invention, where the method includes:

101. At a checkpoint stage, acquire and checkpoint configuration information of a first container, a control group status parameter of the first container, and an application program status parameter of the first container.

In this embodiment of the present invention, when an application program runs in the first container, if a checkpoint/restart operation needs to be performed on the application program, a controller may perform a freezing operation on the first container by using a freezing subsystem in the first container, so as to suspend the application program in the first container.

After the freezing operation is complete, the checkpoint stage is entered. At the checkpoint stage, the controller acquires and checkpoints the configuration information of the first container, the control group status parameter of the first container, and the application program status parameter of the first container, where

the configuration information of the first container includes: an execution area of the first container, the number of virtual terminals used by the first container, a root mount point of the first container, network configuration of the first container, a permission of the first container, a name of a current operating system of the first container, and the like; and

the application program status parameter of the first container includes an application program accessible resource status and a kernel data status for controlling an application program behavior. Specifically, the application program accessible resource status includes: a status of a file resource opened by the application program, memory information within an application program accessible linear address range, timer and signal information, and other information that may be obtained by the application program by means of system calling; and the kernel data status for controlling an application program behavior includes a process relationship and scheduling information of the application program, a security policy, permission and namespace information of the application program, and management information of application program visible resources.

102. At a restart stage, read the configuration information of the first container, the control group status parameter of the first container, and the application program status parameter of the first container, and configure a second container according to the read configuration information of the first container, the read control group status parameter of the first container, and the read application program status parameter of the first container.

In this embodiment of the present invention, at the restart stage, the controller reads the configuration information of the first container, the control group status parameter of the first container, and the application program status parameter of the first container, configures the second container according to the read configuration information of the first container, the read control group status parameter of the first container, and the read application program status parameter of the first container, and implement restart of the application program in the second container.

It should be noted that, in this embodiment of the present invention, “first” and “second” in a first container and a second container are merely used for distinguishing two different containers, but not constitute a limitation on the containers.

In this embodiment of the present invention, at a checkpoint stage, configuration information of a first container, a control group status parameter of the first container, and an application program status parameter of the first container are acquired and checkpointed, so that, at a restart stage, the checkpointed configuration information of the first container, the checkpointed control group status parameter of the first container, and the checkpointed application program status parameter of the first container can be read, a second container is configured according to the read configuration information of the first container, the read control group status parameter of the first container, and the read application program status parameter of the first container, and the restart of the application program is implemented in the second container. The configuration information and the control group status parameter of the first container are configured in the second container, so that configuration information of the second container and a resource limit condition of a process in the second container are consistent with the configuration information in the first container and a resource limit condition of a process in the first container before a checkpoint/restart operation, and an execution environment of a process in the container is kept consistent before and after the checkpoint/restart operation.

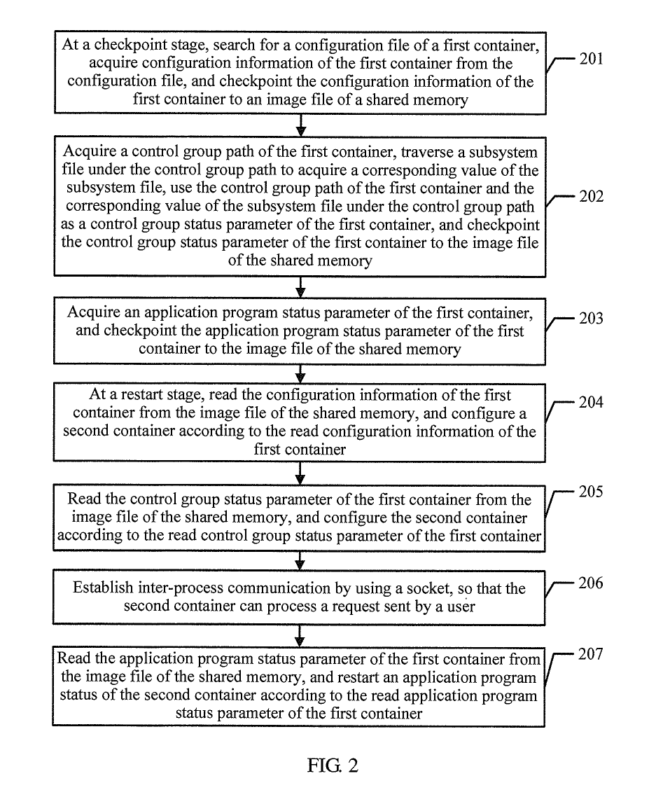

To better understand the method for checkpointing and restarting a container status according to an embodiment of the present invention, the following provides more detailed description. Refer to FIG. 2 which shows an embodiment of a method for checkpointing and restarting a container status according to an embodiment of the present invention, where the method includes:

201. At a checkpoint stage, search for a configuration file of a first container, acquire configuration information of the first container from the configuration file, and checkpoint the configuration information of the first container to an image file of a shared memory.

In this embodiment of the present invention, at the checkpoint stage, a controller searches for the configuration file of the first container, acquires the configuration information of the first container from the configuration file, and checkpoints the configuration information of the first container to the image file of the shared memory, where the checkpointed configuration information includes an execution area of the first container, the number of virtual terminals used by the first container, a root mount point of the first container, network configuration of the first container, a permission of the first container, a name of a current operating system of the first container, and the like.

202. Acquire a control group path of the first container, traverse a subsystem file under the control group path to acquire a corresponding value of the subsystem file, use the control group path of the first container and the corresponding value of the subsystem file under the control group path as a control group status parameter of the first container, and checkpoint the control group status parameter of the first container to the image file of the shared memory.

After the configuration information is checkpointed, the controller acquires the control group path of the first container, traverses the subsystem file under the control group path to acquire the corresponding value of the subsystem file, uses the control group path of the first container and the corresponding value of the subsystem file under the control group path as the control group status parameter of the first container, and checkpoints the control group status parameter of the first container to the image file of the shared memory.

In this embodiment of the present invention, a subsystem under the control group path includes a block device I/O limiting subsystem, a CPU node limiting subsystem, a CPU usage limiting subsystem, a device access permission limiting subsystem, a freezing or defreezing subsystem, a memory size limiting subsystem, and a memory node limiting subsystem.

203. Acquire an application program status parameter of the first container, and checkpoint the application program status parameter of the first container to the image file of the shared memory.

In this embodiment of the present invention, the controller acquires the application program status parameter of the first container, and checkpoints the application program status parameter of the first container to the image file of the shared memory, where the application program status parameter of the first container includes an application program accessible resource status and a kernel data status for controlling an application program behavior. Specifically, the application program accessible resource status includes: a status of a file resource opened by the application program, memory information within an application program accessible linear address range, timer and signal information, and other information that may be obtained by the application program by means of system calling; and the kernel data status for controlling an application program behavior includes a process relationship and scheduling information of the application program, a security policy, permission and namespace information of the application program, and management information of application program visible resources.

204. At a restart stage, read the configuration information of the first container from the image file of the shared memory, and configure a second container according to the read configuration information of the first container.

In this embodiment of the present invention, after the checkpoint stage ends, the restart stage is entered, and the controller reads the configuration information of the first container from the image file of the shared memory, and configures the second container according to the read configuration information of the first container.

It should be noted that, in this embodiment of the present invention, the second container may be a newly established container, and the configuring the second container by using the configuration information of the first container may specifically be that the controller configures the second container by calling a corresponding function according to a different type of configuration information. For example, if an execution area of a second container is configured, a personality function may be called.

205. Read the control group status parameter of the first container from the image file of the shared memory, and configure the second container according to the read control group status parameter of the first container.

In this embodiment of the present invention, after configuring the configuration information of the second container is complete, the controller reads the control group status parameter of the first container from the image file of the shared memory and configures the second container according to the read control group status parameter of the first container.

In this embodiment of the present invention, the control group status parameter of the first container includes the control group path of the first container and the corresponding value of the subsystem file under the control group path; and the configuring the second container by using the control group status parameter of the first container specifically includes: reading the control group status parameter of the first container in the image file of the shared memory, establishing a subsystem file in the second container according to the control group path in the control group status parameter, and writing the corresponding value of the subsystem file under the control group path of the first container into a corresponding subsystem file established in the second container.

206. Establish inter-process communication by using a socket, so that the second container can process a request sent by a user.

In this embodiment of the present invention, for a purpose that the second container can process the request sent by the user, the controller may establish the inter-process communication by using the socket to listen to the request of the user, where the request of the user includes a request for freezing or defreezing a container, a request for viewing status information of a container, a request for stopping running of a container, a request for setting and/or acquiring a resource limit status in a container, and the like; and after receiving the request of the user, the second container performs processing according to a processing method corresponding to the request, and feeds a processing result back to the user.

In this embodiment of the present invention, the establishing inter-process communication by using a socket specifically includes that the controller establishes the socket in the second container, waits for a connecting request of a user side, and if the connecting request of the user side is received, performs corresponding processing according to data included in the connecting request. For example, if a user side requests for acquiring a current container status of a second container, the controller feeds a current container status parameter of the second container to the user side.

207. Read the application program status parameter of the first container from the image file of the shared memory, and restart an application program status in the second container according to the read application program status parameter of the first container.

In this embodiment of the present invention, the controller further reads the application program status parameter of the first container from the image file of the shared memory, and restarts the application program status in the second container according to the read application program status parameter of the first container.

In this embodiment of the present invention, configuration information and a control group status parameter of a first container are configured in a second container, so that configuration information of the second container and a resource limit condition of a process in the second container keep consistent with the configuration information in the first container and a resource limit condition of a process in the first container before a checkpoint/restart operation. In addition, at a restart stage, inter-process communication is established by using a socket, so that the second container can process a request sent by a user, and the user may interact with a container by sending the request, thereby facilitating management of a user.

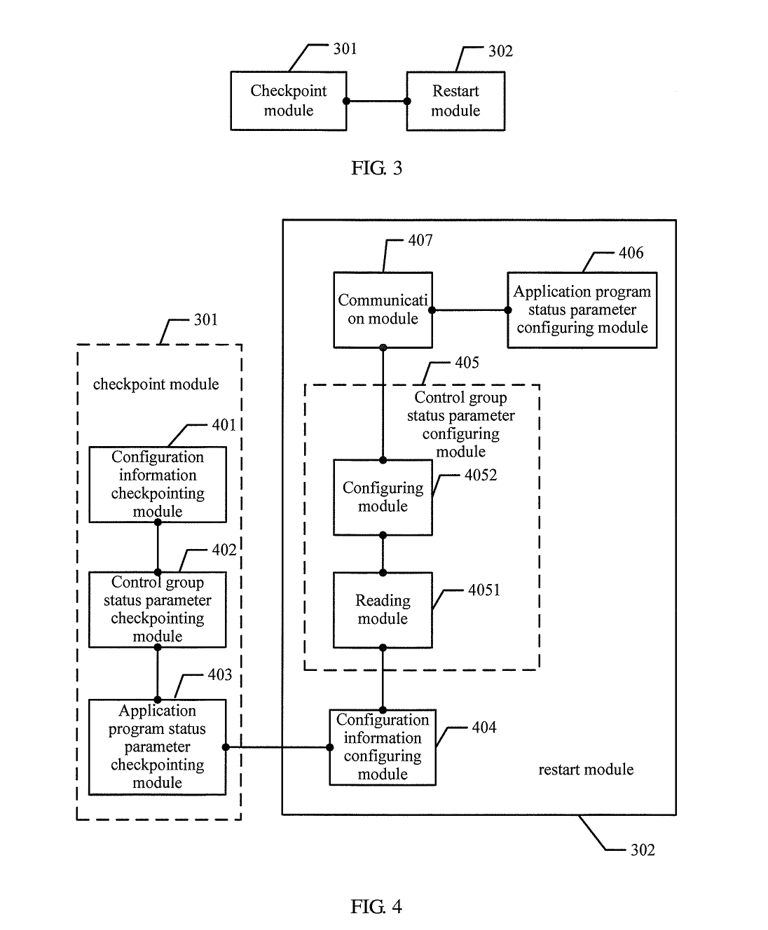

Refer to FIG. 3 which is an embodiment of an apparatus for checkpointing and restarting a container status according to an embodiment of the present invention, where the apparatus includes:

a checkpoint module 301, configured to, at a checkpoint stage, acquire and checkpoint configuration information of a first container, a control group status parameter of the first container, and an application program status parameter of the first container; and

a restart module 302, configured to, at a restart stage, read the configuration information of the first container, the control group status parameter of the first container, and the application program status parameter of the first container, and configure a second container according to the read configuration information of the first container, the read control group status parameter of the first container, and the read application program status parameter of the first container.

In this embodiment of the present invention, at a checkpoint stage, a checkpoint module 301 checkpoints acquired configuration information of a first container, an acquired control group status parameter of the first container, and an acquired application program status parameter of the first container; and at a restart stage, a restart module 302 reads the configuration information of the first container, the control group status parameter of the first container, the application program status parameter of the first container, and configures a second container according to the read configuration information of the first container, the read control group status parameter of the first container, and the read application program status parameter of the first container. The configuration information and the control group status parameter of the first container are configured in the second container, so that configuration information of the second container and a resource limit condition of a process in the second container keep consistent with the configuration information in the first container and a resource limit condition of a process in the first container before a checkpoint/restart operation.

To better describe the apparatus in this embodiment of the present invention, refer to FIG. 4 which shows an embodiment of an apparatus for checkpointing and restarting a container status according to an embodiment of the present, where the apparatus includes:

the checkpoint module 301 and the restart module 302 in the embodiment shown in FIG. 3, of which content is consistent with content described in the embodiment shown in FIG. 3, and details are not described herein again.

In this embodiment of the present invention, the checkpoint module 301 includes:

a configuration information checkpointing module 401, configured to search for a configuration file of a first container, acquire configuration information of the first container from the configuration file, and checkpoint the configuration information of the first container to an image file of a shared memory;

a control group status parameter checkpointing module 402, configured to acquire a control group path of the first container, traverse a subsystem file under the control group path to acquire a corresponding value of the subsystem file, use the control group path of the first container and the corresponding value of the subsystem file under the control group path as a control group status parameter of the first container, and checkpoint the control group status parameter of the first container to the image file of the shared memory; and

an application program status parameter checkpointing module 403, configured to acquire an application program status parameter of the first container, and checkpoints the application program status parameter of the first container to the image file of the shared memory.

In this embodiment of the present invention, the restart module 302 includes:

a configuration information configuring module 404, configured to, at a restart stage, read the configuration information of the first container from the image file of the shared memory, and configure a second container according to the read configuration information of the first container;

a control group status parameter configuring module 405, configured to read the control group status parameter of the first container from the image file of the shared memory, and configure the second container according to the read control group status parameter of the first container; and

an application program status parameter configuring module 406, configured to read the application program status parameter of the first container from the image file of the shared memory, and restarts an application program status in the second container according to the read application program status parameter of the first container.

The control group status parameter configuring module 405 includes:

a reading module 4051, configured to read the control group status parameter in the image file of the shared memory, where the control group status parameter includes the control group path of the first container and the corresponding value of the subsystem file under the control group path;

a configuring module 4052, configured to establish a subsystem file in the second container according to the control group path, and write the corresponding value of the subsystem file under the control group path of the first container into a corresponding subsystem file established in the second container.

The restart module in this embodiment of the present invention further includes:

a communication module 407, configured to establish inter-process communication by using a socket, so that the second container can process a request sent by a user.

In this embodiment of the present invention, at the checkpoint stage, the configuration information checkpointing module 401 in the checkpoint module 301 searches for the configuration file of the first container, acquires the configuration information of the first container from the configuration file, and checkpoints the configuration information of the first container to the image file of the shared memory; the control group status parameter checkpointing module 402 acquires the control group path of the first container, traverses the subsystem file under the control group path to acquire the corresponding value of the subsystem file, uses the control group path of the first container and the corresponding value of the subsystem file under the control group path as the control group status parameter of the first container, and checkpoints the control group status parameter of the first container to the image file of the shared memory; and finally, the application program status parameter checkpointing module 403 acquires the application program status parameter of the first container, and checkpoints the application program status parameter of the first container to the image file of the shared memory.

In this embodiment of the present invention, after the checkpoint stage ends, at the restart stage, the configuration information configuring module 404 in the restart module reads the configuration information of the first container from the image file of the shared memory, and configures the second container according to the read configuration information of the first container; then, the control group status parameter configuring module 405 reads the control group status parameter of the first container from the image file of the shared memory, and configures the second container according to the read control group status parameter of the first container; then, the communication module 407 establishes the inter-process communication by using the socket, so that the second container can process the request sent by the user; and finally, the application program status parameter configuring module 406 reads the application program status parameter of the first container from the image file of the shared memory, and restarts the application program status in the second container according to the read application program status parameter of the first container.

In this embodiment of the present invention, a specific method for configuring the second container by the control group status parameter configuring module 405 includes: reading, by the reading module 4051, the control group status parameter from the image file of the shared memory, where the control group status parameter includes the control group path of the first container and the corresponding value of the subsystem file under the control group path; and establishing, by the configuring module 4052, the subsystem file in the second container according to the control group path, and writing the corresponding value of the subsystem file under the control group path of the first container into a corresponding subsystem file in the second container.

In this embodiment of the present invention, configuration information and a control group status parameter of a first container are configured in a second container, so that configuration information of the second container and a resource limit condition of a process in the second container keep consistent with the configuration information in the first container and a resource limit condition of a process in the first container before a checkpoint/restart operation. In addition, at a restart stage, inter-process communication is established by using a socket, so that the second container can process a request sent by a user, and the user may interact with a container by sending the request, thereby facilitating management of a user.

It should be noted that the apparatus for checkpointing and restarting a container status according to the embodiments shown in FIG. 3 and FIG. 4 may be a controller in a Linux system, where the controller can acquire a container status from the container, checkpoints the container status to a shared memory, and reads the container status from the shared memory, thereby implementing the checkpoint/restart operation.

A person of ordinary skill in the art may understand that all or a part of the steps of the methods in the embodiments may be implemented by a program instructing relevant hardware. The program may be stored in a computer readable storage medium. The storage medium mentioned above may be a read-only memory, a magnetic disk, an optical disc, or the like.

The foregoing describes the method and the apparatus for checkpointing and restarting a container status in detail according to the present invention. With respect to the implementations and the application program scope, modifications may be made by a person skilled in the art according to the idea of the embodiments of the present invention. Therefore, content of the specification shall not be construed as a limitation on the present invention.

What is claimed is:

1. A method for checkpointing and restarting a container status, the method comprising:
at a checkpoint stage, acquiring and checkpointing configuration information of a first container, a control group status parameter of the first container, and an application program status parameter of the first container; and
at a restart stage, reading the configuration information of the first container, the control group status parameter of the first container, and the application program status parameter of the first container, and configuring a second container according to the read configuration information of the first container, the read control group status parameter of the first container, and the read application program status parameter of the first container.

2. The method according to claim 1, wherein acquiring and checkpointing configuration information of a first container, a control group status parameter of the first container, and an application program status parameter of the first container, comprises:
searching for a configuration file of the first container, acquiring the configuration information of the first container from the configuration file, and checkpointing the configuration information of the first container to an image file of a shared memory;
acquiring a control group path of the first container, traversing a subsystem file under the control group path to acquire a corresponding value of the subsystem file, using the control group path of the first container and the corresponding value of the subsystem file under the control group path as the control group status parameter of the first container, and checkpointing the control group status parameter of the first container to the image file of the shared memory; and
acquiring the application program status parameter of the first container, and checkpointing the application program status parameter of the first container to the image file of the shared memory.

3. The method according to claim 2, wherein reading the configuration information of the first container, the control group status parameter of the first container, and the application program status parameter of the first container, and configuring a second container according to the read configuration information of the first container, the read control group status parameter of the first container, and the read application program status parameter of the first container, comprises:
at the restart stage, reading the configuration information of the first container from the image file of the shared memory, and configuring the second container according to the read configuration information of the first container;
reading the control group status parameter of the first container from the image file of the shared memory, and configuring the second container according to the read control group status parameter of the first container; and
reading the application program status parameter of the first container from the image file of the shared memory, and restarting an application program status in the second container according to the read application program status parameter of the first container.

4. The method according to claim 3, wherein reading the control group status parameter of the first container from the image file of the shared memory, and configuring the second container according to the read control group status parameter of the first container, comprises:
reading the control group status parameter of the first container in the image file of the shared memory, wherein the control group status parameter comprises the control group path of the first container and the corresponding value of the subsystem file under the control group path; and
establishing a subsystem file in the second container according to the control group path, and writing the corresponding value of the subsystem file under the control group path of the first container into a corresponding subsystem file established in the second container.

5. The method according to claim 3, wherein after reading the control group status parameter of the first container from the image file of the shared memory, and configuring the second container according to the read control group status parameter of the first container, the method further comprises:
establishing inter-process communication by using a socket, so that the second container can process a request sent by a user.

6. An apparatus for checkpointing and restarting a container status, the apparatus comprising:
a checkpoint module, configured to, at a checkpoint stage, acquire and checkpoint configuration information of a first container, a control group status parameter of the first container, and an application program status parameter of the first container; and
a restart module, configured to, at a restart stage, read the configuration information of the first container, the control group status parameter of the first container, and the application program status parameter of the first container, and configure a second container according to the read configuration information of the first container, the read control group status parameter of the first container, and the read application program status parameter of the first container.

7. The apparatus according to claim 6, wherein the checkpoint module comprises:
a configuration information checkpointing module, configured to search for a configuration file of the first container, acquire the configuration information of the first container from the configuration file, and checkpoint the configuration information of the first container to an image file of a shared memory;
a control group status parameter checkpointing module, configured to acquire a control group path of the first container, traverse a subsystem file under the control group path to acquire a corresponding value of the subsystem file, use the control group path of the first container and the corresponding value of the subsystem file under the control group path as the control group status parameter of the first container, and checkpoint the control group status parameter of the first container to the image file of the shared memory; and
an application program status parameter checkpointing module, configured to acquire the application program status parameter of the first container, and checkpoint the application program status parameter of the first container to the image file of the shared memory.

8. The apparatus according to claim 6, wherein the restart module comprises:
a configuration information configuring module, configured to, at the restart stage, read the configuration information of the first container from an image file of a shared memory, and configure the second container according to the read configuration information of the first container;
a control group status parameter configuring module, configured to read the control group status parameter of the first container from the image file of the shared memory, and configure the second container according to the read control group status parameter of the first container; and
an application program status parameter configuring module, configured to read the application program status parameter of the first container from the image file of the shared memory, and restart the application program status in the second container according to the read application program status parameter of the first container.

9. The apparatus according to claim 8, wherein the control group status parameter configuring module comprises:
a reading module, configured to read the control group status parameter from the image file of the shared memory, wherein the control group status parameter comprises a control group path of the first container and a corresponding value of a subsystem file under the control group path; and
a configuring module, configured to establish a subsystem file in the second container according to the control group path, and write the corresponding value of the subsystem file under the control group path of the first container into a corresponding subsystem file established in the second container.

10. The apparatus according to claim 8, wherein the restart module further comprises:
a communication module, configured to establish inter-process communication by using a socket, so that the second container can process a request sent by a user.

11. The apparatus according to claim 9, wherein the restart module further comprises:
a communication module, configured to establish inter-process communication by using a socket, so that the second container can process a request sent by a user.
